(19) United States
(12) Patent Application Publication
(10) Pub. No.: US 2026/0367444 A1
(43) Pub. Date: Nov. 19, 2026

(54) LIQUID CRYSTAL LAMINATED GLASS WITH POLARIZER, MANUFACTURING METHOD THEREFOR AND VEHICLE INCLUDING THE SAME

(71) Applicant: FUYAO GLASS INDUSTRY GROUP CO., LTD., Fuqing (CN)

(72) Inventor: Wenhai Wang, Fuqing, Fujian (CN)

(21) Appl. No.: 19/129,912

(22) PCT Filed: Nov. 14, 2023
(86) PCT No.: PCT/CN2023/131496

§ 371 Date: May 14, 2025

(30) Foreign Application Priority Data
Nov. 14, 2022 (CN) 202211421271.5

(51) Int. Cl. G02F 1/1335; G02F 1/1339

(52) U.S. Cl. CPC G02F 1/133528; G02F 1/1339; G02F 2202/28

(57) ABSTRACT

A liquid crystal laminated glass with polarizers, a manufacturing method therefor, and a vehicle including the same. An upper polarizer and a lower polarizer of a polarizing liquid crystal element are separated from a film substrate, and are respectively laminated with an upper glass and a lower glass through a polymer interlayer to form an upper laminate and a lower laminate; and a liquid crystal element without the upper polarizer and the lower polarizer is integrated with the upper laminate and the lower laminate by arranging, crosslinking and curing a liquid optically clear adhesive, to form a multi-layer liquid crystal laminated glass. The two polarizers are separated from the film substrate of the liquid crystal element, such that even if the polarizers are expanded or warped after being heated or irradiated, the liquid crystal element will not be compressed, thereby preventing visual defects.

### RELATED APPLICATION

The present disclosure claims priority of Chinese Patent Application No.202211421271.5, an invention title of “liquid crystal laminated glass with polarizer, preparation method thereof and vehicle including the same” and filed to China National Intellectual Property Administration on Nov. 14, 2022, the entire contents of which are hereby incorporated by reference.

### TECHNICAL FIELD

The present disclosure relates to the field of automobile glass, and particularly to a liquid crystal laminated glass with polarizers, a manufacturing method therefor and a vehicle including the same.

### BACKGROUND

At present, the laminated vehicle window with variable transmittance realized by means of liquid crystals mostly adopts guest-host type liquid crystal elements, and the laminated vehicle window containing liquid crystal elements is formed by laminating with a polymer interlayer, or arranging a liquid optically clear adhesive followed by crosslinking and curing. The guest-host type liquid crystal element reorienting liquid crystal molecules therein and align the dichroic dye molecules, thereby realizing the modulation of the transmittance. Another type is a polarizing liquid crystal element, which usually adopts a flexible material as a base material, such as polyethylene terephthalate (PET) or polycarbonate (PC) in practical applications. This type of liquid crystal element has a linear polarizer on either side thereof and the polarization directions are perpendicular to each other. The liquid crystal element is encapsulated with a film substrate and a sealing joint, and the liquid crystal element is internally provided with a liquid crystal mixture, an electrode layer and an orientation layer, without containing dye molecules. Natural light becomes linearly polarized light after passing through a first polarizer, and the liquid crystal molecules rotate under the action of an electric field to adjust a polarization direction of incident light. According to Marius' law, the transmittance is proportional to the square of a cosine value of an angle between a polarization direction of incident light of a second polarizer and a transmission axis of the polarizer.

At present, there are three conventional modes to realize the laminated vehicle window with a variable transmittance liquid crystal element:
a. a liquid crystal element is placed between two layers of glass (one of which is a laminated glass) by the arrangement, crosslinking and curing of a liquid optically transparent adhesive; for example, referring to Chinese patent publication CN112351883A;
b. firstly, a liquid crystal element, a polymer interlayer and a glass are bonded by means of lamination to form a laminated assembly, and then the laminated assembly is combined with another layer of glass by the arrangement, crosslinking and curing of a liquid optically clear adhesive to form a laminated vehicle window; for example, referring to Chinese patent publication CN114585507A;
c. a liquid crystal element and a single-layer polarizer are connected to a body of a vehicle window glass by an adhesive material to form a composite structure; for example, referring to Chinese patent publication CN110869837A.

A common point of the modes a and b is that one or both sides of the liquid crystal element are in contact with the liquid optically clear adhesive. Since the liquid optically clear adhesive is in a liquid state with a low viscosity (generally, the viscosity is 100 to 6000 mPa.s, and the conventional viscosity is 200 to 2000 mPa.s) before curing and a low hardness (generally, Shore 00 40 to 60) after curing, a force applied to the liquid crystal element before and after the curing of the liquid optically clear adhesive is small, and it is not easy to form permanent visual defects during the curing process.

A polarizer is attached to the film substrate of the polarizing flexible liquid crystal element. The material of the polarizer is different from that of the film substrate, which leads to a certain difference in the thermal expansion coefficient, and a residual stress is formed during the manufacturing and the packaging of the polarizer. Due to the above reasons, the polarizing flexible liquid crystal film element is prone to an expansion or a warpage deformation after being heated or irradiated. If the polarization directions of the upper polarizer and the lower polarizer are perpendicular to each other, the warpage directions of two sides of the polarizing flexible liquid crystal element may be perpendicular to each other. The liquid optically clear adhesive is soft after curing, and it is difficult to restrict the expansion and the warpage deformation of the polarizing flexible liquid crystal element itself, which lead to the change of the thickness in the adjacent liquid crystal cell, and further leads to a local transmittance non-uniformity or color unevenness (Mura phenomenon) of the liquid crystals in the affected area. Since it is difficult for the warpage deformation of the polarizing flexible liquid crystal element itself to fully self-recover after being subjected to a high temperature or an intense irradiation, the visual defects of the liquid crystal element may partially remain to cause a permanent visual problem. When the deformation is serious, it may even lead to problems such as a local liquid crystal loss of the liquid crystal element or a fracture of the film substrate, thereby permanently losing the transmittance modulate function.

The mode a requires at least three layers of glass, which greatly increases the thickness and the weight of the product, and does not conform to the existing environmental protection concepts of lightweight vehicle bodies and energy consumption reduction. In mode b, the liquid crystal element and the glass are bonded by lamination. The traditional automobile glass lamination process generally requires a high temperature above 130 °C and a pressure above 1 MPa. Since the liquid crystals and the dye molecules in the existing liquid crystal element are highly sensitive to the cell gap and the processing temperature of the liquid crystal element, a process temperature above 100 °C and a pressure above 0.1 MPa often lead to local visual defects of the liquid crystal element in the lamination process, and these defects cannot be eliminated. In order to solve this problem, special materials such as low temperature ethylene-vinyl acetate copolymer (EVA) and thermoplastic polyurethane (TPU) are often adopted in the lamination process of curved glass. Even if low-temperature materials are adopted, a temperature above 100 °C and a pressure above 0.1 MPa are usually required to form a uniform, transparent and bubble-free laminated vehicle window, and it often requires the development and verification of special new materials, complicated process debugging and a longer lamination time. The low-temperature and low-pressure lamination process may also bring about problems such as a weak adhesion of a bonding material and incomplete gas removal, which poses potential risks to the product reliability. Experiments conducted by the inventor have proven that if the lamination is carried out at a low temperature below 110 °C and a pressure of 1 bar, a large number of bubbles will easily appear between polyvinyl butyral (PVB), which is a conventional material of a polymer bonding layer, and the liquid crystal element after a high-temperature test. In mode c, the liquid crystal element is connected to an inner or outer vehicle window glass through the bonding layer, and a single polarizer is arranged between the liquid crystal element and the inner or outer vehicle window glass. In order to achieve a shielding effect, the liquid crystal element in mode c must have a polarization property to achieve the shielding effect after being combined with the polarizer. In practical applications, the polarization degree of the liquid crystal element with the polarization property is limited, that is, natural light is not a completely linearly polarized light after being filtered by the liquid crystal element, which leads to a high dark-state transmittance or a narrow overall transmittance modulation range of the liquid crystal element with a single polarizer.

### SUMMARY

The present disclosure aims to provide a liquid crystal laminated glass with polarizers, a manufacturing method therefor and a vehicle including the same. In the present disclosure, an upper polarizer and a lower polarizer of a polarizing liquid crystal element are separated from a film substrate to be combined with upper and lower glass, respectively, and then integrated with the liquid crystal element encapsulated with the film substrate to form a laminated vehicle window glass. In this way, it is possible to avoid a local transmittance or Mura of the liquid crystal element caused by a thermal expansion coefficient, an original stress, etc. between the polarizer and the film substrate, as well as defects of the liquid crystal element caused by a temperature and a pressure required in a lamination process such as permanent visual defect, a liquid crystal loss, bubbles, etc.

In order to achieve the above objectives, the present disclosure adopts the following technical solutions:

In an aspect of the present disclosure, there is provided a method for manufacturing a liquid crystal laminated glass with polarizers, including the steps of:
combining an upper polarizer with an upper glass to form an upper laminate;
combining a lower polarizer with a lower glass to form a lower laminate; and
integrating: sandwiching a film substrate-encapsulated liquid crystal element without polarizer, between the upper laminate and the lower laminate by arranging, crosslinking and curing a liquid optically clear adhesive, thereby forming the liquid crystal laminated glass.

In the manufacturing method of the present disclosure, the two polarizers are separated from the film substrate of the liquid crystal element, with the liquid optically clear adhesive filled therebetween, so that even if the polarizers are expanded and warped after being heated or irradiated, the liquid crystal element will not be compressed to cause visual defects. Moreover, the liquid crystal element adopts an attaching process of the liquid optically clear adhesive, so as to avoid the permanent visual defects or other defects of the liquid crystal element caused by the temperature and the pressure required in a lamination process.

According to the manufacturing method of the present disclosure, exemplarily, the liquid optically clear adhesive may be selected from one or more materials selected from the group consisting of acrylic, polyvinyl acetate (PVA), polyurethane (PU), silicone resin, epoxy resin, etc.

According to the method for manufacturing of the present disclosure, exemplarily, a process of forming the upper laminate includes:
sequentially stacking an upper glass, a first polymer interlayer, an upper polarizer, a first barrier layer and a first back glass to form a laminated structure; after relative positions are fixed, placing the laminated structure into a vacuum bag and laminating by means of a low-temperature and high-pressure process; after lamination, removing the vacuum bag, the first barrier layer and the first back glass, and holding an upper laminate formed by the upper glass, the first polymer interlayer and the upper polarizer. In this process, the first polymer interlayer is recessed 1 to 10 mm relative to a glass edge for the subsequent arrangement of a perimeter seal.

According to the manufacturing method of the present disclosure, exemplarily, a process of forming the lower laminate includes:
sequentially stacking a lower glass, a second polymer interlayer, a lower polarizer, a second barrier layer and a second back glass to form a laminated structure; after relative positions are fixed, placing the laminated structure into a vacuum bag and laminating by means of a low-temperature and high-pressure process; after lamination, removing the vacuum bag, the second barrier layer and the second back glass, and holding a lower laminate formed by the lower glass, the second polymer interlayer and the lower polarizer. In this process, the second polymer interlayer is recessed 1 to 10 mm relative to a glass edge for the subsequent arrangement of a perimeter seal.

In the above processes of forming the upper laminate and the lower laminate, the polarizer is bonded to the glass using the polymer interlayer and the lamination process, and a high pressure may be adopted, thereby avoiding the complicated lamination process debugging and the problems of a weak adhesion of an adhesive material, an incomplete gas removal, etc. that may be caused by a low-pressure process, and better matching the original production line and operators. Exemplarily, the lamination process employs a low-temperature and high-pressure process with pressure exceeding 10 bar and temperature ranging from 80 °C to 110 °C.

In addition, the firm adhesion formed in the lamination process of the upper laminate and the lower laminate can effectively suppress the expansion and warpage tendency of the polarizers. In which, the polymer interlayer can effectively block ultraviolet rays in sunlight and protect the internal liquid crystal element.

During the manufacturing of the upper laminate and the lower laminate, the back glass may be used to ensure that the surface of the polymer interlayer is flat, the barrier layer may be used to ensure that the back glass is removed smoothly after lamination, and the barrier layer with the smooth and flat surface can ensure that the surface of the polymer interlayer is smooth and flat in the lamination process. In addition, due to the reasons such as an organic solvent may damage a part of the polymer interlayer, the surface of the polymer interlayer should be kept as uncleaned or as little cleaned as possible. Therefore, the barrier layer may not be removed temporarily in the subsequent process, so as to continuously protecting the polymer interlayer from being contaminated.

According to the manufacturing method of the present disclosure, exemplarily, the material of the barrier layer is selected from Polyethylene Terephthalate (PET), nylon, siloxane, Teflon, etc. ; the barrier layer may be of one layer or multiple layers, and a size of the barrier layer should be at least equal to or greater than an external size of the glass.

According to the manufacturing method of the present disclosure, exemplarily, the material of the first polymer interlayer and the second polymer interlayer may be selected from the following polymers: polyvinyl butyral (PVB), ethylene vinyl acetate (EVA), polyurethane (PU), polyethylene terephthalate (PET), polyethylene, polycarbonate, polymethyl methacrylate, polyacrylate, polyvinyl chloride, polyacrylate resin, acrylate copolymer, fluorinated ethylene propylene, polyvinyl fluoride, ethylene tetrafluoroethylene and cyclic olefin copolymer (COC). By selecting the material and the composition of the polymer interlayer, it is possible to main the mechanical strength of the glass, and also achieve many functions such as sound insulation, infrared and ultraviolet blocking, coloring, etc.

According to the manufacturing method of the present disclosure, exemplarily, a specific process of the integrating includes: making the liquid crystal element be embedded into the liquid optically clear adhesive and interposed between the upper laminate and the lower laminate; after the liquid optically clear adhesive is cured, the upper laminate and the lower laminate are bonded together by the liquid optically clear adhesive to form the liquid crystal laminated glass.

According to the method for manufacturing of the present disclosure, exemplarily, before the integrating, a perimeter seal is disposed on edges of the upper laminate and the lower laminate, to keep a distance between the upper laminate and the lower laminate when they are bonded by the liquid optically clear adhesive; and an opening is reserved on the perimeter seal to allow the liquid optically clear adhesive to be poured in the integrating. Alternatively:
the liquid optically clear adhesive is arranged in the upper laminate or the lower laminate in advance and embedded with the liquid crystal element, then the upper laminate and the lower laminate are combined, and after the liquid optically clear adhesive is cured, a perimeter seal is disposed on opposite peripheral edges of the upper laminate and the lower laminate.

In an exemplary solution, before the integrating, a perimeter seal is disposed between a peripheral area of the liquid crystal element and one of the upper laminate and the lower laminate. The perimeter seal may be a double-sided adhesive tape with a relatively fixed thickness (e.g., 3M VHB series), or a silicone or polyurethane structural adhesive with a thickness and a width, or both the double-sided tape with a fixed thickness and the structural adhesive. The perimeter seal has a width of 1 to 10 mm and a height of 0.1 to 2 mm. Two or more openings are reserved on the perimeter seal to allow the liquid optically clear adhesive to be poured.

As another exemplary solution, the liquid optically clear adhesive may be disposed on a surface of one of the upper laminate and the lower laminate opposite to the liquid crystal element or a surface of the liquid crystal element opposite to the laminate, then the one of the upper laminate and the lower laminate is bonded with the liquid crystal element, and after the liquid optically clear adhesive is cured, the bonding between the one of the upper laminate and the lower laminate and the liquid crystal element can be completed;
after the liquid crystal element is integrated with the one of the upper laminate and the lower laminate, a perimeter seal is disposed in a recessed area of the polymer interlayer along the edges of the upper laminate and the lower laminate. The perimeter seal may be selected from a double-sided tape with a relatively fixed thickness (e.g., 3M VHB series), or a silicone or polyurethane structural adhesive with a thickness and a width, or both the double-sided tape with a fixed thickness and the structural adhesive. The perimeter seal has a width of 1 to 10 mm, and a height of 0.2 to 2 mm or more than the sum of the thicknesses of the liquid crystal element, the upper polarizer, the lower polarizer, the first polymer interlayer and the second polymer interlayer.

The perimeter seal is primarily configured to connect the upper laminate and the lower laminate, and cooperatively forms an enclosed structure with an internal space of a predetermined height t, so as to prevent external particles, moisture, liquid, etc. from entering the enclosed structure. The perimeter seal may be black and opaque, or made of a transparent material that can block the transmission of ultraviolet rays to avoid the aging of the liquid crystal element caused by ultraviolet rays entering the product through the glass edge. The opening is reserved on the perimeter seal to allow the liquid optically clear adhesive to be poured in the integrating. After the liquid optically clear adhesive is poured, the opening for pouring may be closed by secondary adhesive injection.

In another exemplary solution, after the liquid crystal element is integrated with one of the upper laminate and the lower laminate, a barrier material such as polytetrafluoroethylene or siloxane is optionally arranged in a contracted area of the polymer interlayer between the upper laminate and the lower laminate. The barrier material has a height of 0.2 to 2 mm or more than the sum of the thicknesses of the liquid crystal element, the upper polarizer, the lower polarizer, the first polymer interlayer and the second polymer interlayer. Then, the liquid optically clear adhesive is disposed on a surface of the other of the upper laminate and the lower laminate or the liquid crystal element to combine the upper laminate and the lower laminate, and the barrier material is removed after the liquid optically clear adhesive is cured. The perimeter seal is disposed in a gap between opposite peripheries of the upper laminate and the lower laminate by injecting a silicone or polyurethane structural adhesive.

In another aspect of the present disclosure, there is provided a liquid crystal laminated glass with polarizers, which is obtained by the aforementioned manufacturing method.

Specifically, the liquid crystal laminated vehicle window glass includes an upper glass, a first polymer interlayer, an upper polarizer, a liquid optically clear adhesive, a lower polarizer, a second polymer interlayer and a lower glass which are sequentially laminated;
the liquid optically clear adhesive contains embedded liquid crystal element, and the upper polarizer, the liquid crystal element and the lower polarizer are correspondingly aligned in a lamination direction.

The liquid crystal element may be located exactly in a middle position between the upper polarizer and the lower polarizer, or closer to one side, that is, the thicknesses of the adhesive between the liquid crystal element and the upper polarizer, and the adhesive between the liquid crystal element and lower polarizer may be different. Generally, the adhesives on the two sides are applied through two operations, and liquid optically clear adhesives with different compositions may also be employed.

The liquid crystal laminated glass further includes a perimeter seal, which is disposed on peripheral edges of the upper glass and the lower glass, and two ends of the perimeter seal are connected to the upper glass and the lower glass, respectively.

The present disclosure has the following advantageous effects:
1) In the existing technologies of the liquid crystal laminated glass (e.g., the three modes in the Background section), guest-host liquid crystal elements are mostly used, and it is generally difficult for this type of liquid crystal elements to reduce the transmittance below 1% (unless a bright-state transmittance is reduced below 15%), which causes the problem of a high dark-state transmittance. In addition, the guest-host liquid crystal elements currently available on the market have the problems such as a significantly increased response time (>10 s) at a low temperature, which limit the application of this type of elements in the field of passenger vehicles. Due to the orthogonal arrangement of the upper polarizer and the lower polarizer, the transmittance of the polarizing liquid crystal element can be easily below 1% while ensuring a bright-state transmittance of 30% or more, so that the adjustment range of the transmittance is more optimal.
2) The two polarizers are separated from the film substrate of the liquid crystal element, with the liquid optically clear adhesive filled therebetween, such that even if the polarizers are expanded and warped after being heated or irradiated, the liquid crystal element will not be compressed to cause Mura or other defects.
3) The polarizer is bonded to the glass using the polymer interlayer and the lamination process, and a high pressure (10 bar or more) may be adopted, thereby avoiding the complicated lamination process debugging and the problems of a weak adhesion of an adhensive material, an incomplete gas removal, etc., which may be caused by a low-pressure process, and better matching the original production line and operators; in addition, the firm adhesion formed in the lamination process of the upper laminate and the lower laminate can effectively suppress the expansion and warpage tendency of the polarizers.
4) The liquid crystal element uses an attaching process of the liquid optically clear adhesive, so as to avoid the permanent appearance defects or other defects of the liquid crystal element caused by the temperature and the pressure required in the lamination process.
5) During the manufacturing of the upper laminate and the lower laminate, the back glass may be employed to ensure that the surface of the polymer interlayer is flat, the barrier layer may be used to ensure that the back glass is removed smoothly after lamination, and the barrier layer with the smooth and flat surface can ensure that the surface of the polymer interlayer is smooth and flat in the lamination process; in addition, the barrier layer may not be removed temporarily in the subsequent process, so as to continuously protecting the polymer interlayer from being contaminated.
6) The polymer interlayer in the upper laminate can effectively block ultraviolet rays in sunlight and protect the internal liquid crystal element.
7) The perimeter seal is directly connected to the upper glass and the lower glass, which increases an adhesion force between the upper glass and the lower glass, and partially prevents product damage caused by misalignment under external shear force.

### BRIEF DESCRIPTION OF THE DRAWINGS

FIG. 1 illustrates a schematic diagram of a process of forming an upper laminate and a lower laminate according to the present disclosure.

FIG. 2 illustrates a structural diagram of a liquid crystal laminated glass with polarizers according to the present disclosure.

FIG. 3 illustrates a structural diagram of a liquid crystal laminated glass with polarizers according to another exemplary embodiment of the present disclosure.

### REFERENCE NUMERALS

1—glass, 11—upper glass, 12—lower glass;
2—polymer interlayer, 21—first polymer interlayer, 22—second polymer interlayer;
3—polarizer, 31—upper polarizer, 32—lower polarizer;
4—barrier layer, 41—first barrier layer, 42—second barrier layer;
5—back glass;
6—liquid optically clear adhesive;
7—liquid crystal element;
8—perimeter seal.

### DETAILED DESCRIPTION OF THE EMBODIMENTS

In order to explain the present disclosure more clearly, the present disclosure will be further described with reference to the exemplary embodiments. It should be understood by those skilled in the art that the following detailed description is illustrative rather than restrictive, and should not be used to limit the protection scope of the present disclosure.

The main technical solution according to the present disclosure is realized in the following process: separating an upper polarizer and a lower polarizer of a polarizing liquid crystal element from a film substrate, laminating the upper polarizer and an upper glass through a first polymer interlayer to form an upper laminate, and laminating the lower polarizer and a lower glass through a second polymer interlayer to form a lower laminate; and integrating the liquid crystal element without the upper polarizer and the lower polarizer with the upper laminate and the lower laminate by arranging and curing an liquid optically clear adhesive, thereby forming a multilayer liquid crystal laminated glass.

In the present disclosure, the two polarizers are separated from the film substrate of the liquid crystal element, with the liquid optically clear adhesive filled therebetween, such that even if the polarizers are warped after being heated or irradiated, the liquid crystal element will not be compressed, thereby preventing visual defects. Moreover, the liquid crystal element adopts an attaching process of the liquid optically clear adhesive, so as to avoid the permanent Mura or other defects of the liquid crystal element caused by the temperature and the pressure required in a lamination process. In addition, the firm bonding formed in the lamination process of the upper laminate and the lower laminate can also effectively suppress the warpage tendency of the polarizers.

A method for manufacturing a liquid crystal laminated glass with polarizers of the present disclosure mainly includes the following steps:
combining an upper polarizer with an upper glass to form an upper laminate;
combining a lower polarizer with a lower glass to form a lower laminate; and
integrating: sandwiching a film substrate-encapsulated liquid crystal element without polarizer, between the upper laminate and the lower laminate by the arranging, crosslinking and curing a liquid optically clear adhesive, thereby forming the liquid crystal laminated glass.

In which, the liquid optically clear adhesive may be selected from one or more materials selected from the group consisting of acrylic polymers, polyvinyl acetate (PVA), polyurethane (PU), silicone resin, epoxy resin, etc.

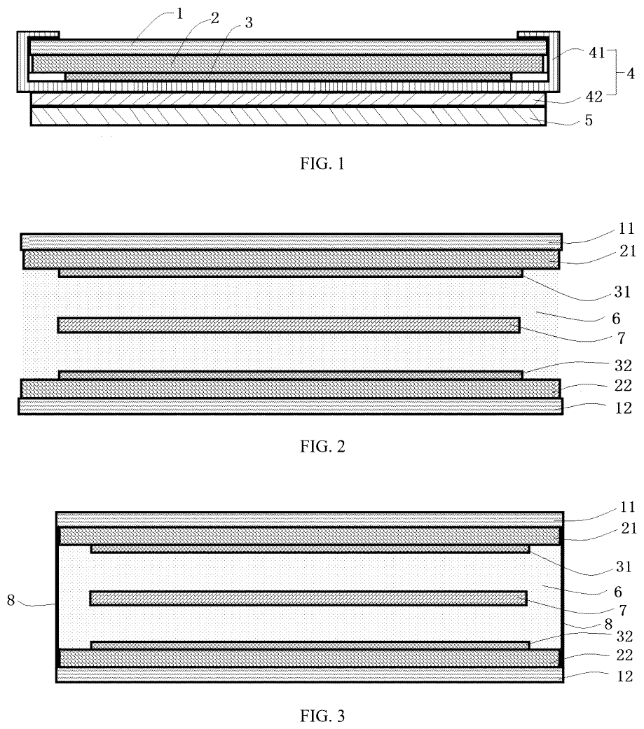

As illustrated in FIG. 1, the upper laminate and the lower laminate may be specifically formed in the following process:
sequentially stacking a glass 1, a polymer interlayer 2, a polarizer 3, a barrier layer 4 and a back glass 5 to form a laminated structure; after relative positions are fixed, placing the laminated structure into a vacuum bag and laminating by means of a low-temperature and high-pressure (10 bar or more) process; after lamination, removing the vacuum bag, the barrier layer 4 and the back glass 5, and holding a laminated structure formed by the glass 1, the polymer interlayer 2 and the polarizer 3, that is, an upper laminate or a lower laminate. In this process, the polymer interlayer is recessed 1 to 10 mm from a glass edge to accommodate the subsequent arrangement of a perimeter seal.

In the processes of forming the upper laminate and the lower laminate, the polarizer 3 is bonded to the glass 1 by utilizing the polymer interlayer 2 and the lamination process, and a high pressure (10 bar or more) may be adopted, thereby avoiding the complicated lamination process debugging and the problems of a weak adhesion of a bonding material, an incomplete gas removal, etc. that may be caused by a low-pressure process, and better matching the original production line and operators. Exemplarily, the pressure of the low-temperature and high-pressure process employed in the lamination is 10 bar or more, such as 10 to 13 bar, and the temperature is between 110 °C and 80 °C.

The material of the barrier layer 4 is exemplarily selected from PET, nylon, Teflon, etc. The barrier layer 4 may be of one layer or multiple layers, and a size of the barrier layer 4 should be at least equal to or greater than an external size of the glass 1. For example, the barrier layer in FIG. 1 includes a first barrier layer 41 and a second barrier layer 42, wherein the first barrier layer 41 may also form a semi-enclosed structure to enclose and fix the laminated structure of the glass 1, the polymer interlayer 2 and the polarizer 3.

The material of the polymer interlayer may be selected from the following polymers: polyvinyl butyral (PVB), ethylene vinyl acetate (EVA), polyurethane (PU), polyethylene terephthalate (PET), polyethylene, polycarbonate, polymethyl methacrylate, polyacrylate, polyvinyl chloride, polyacrylate resin, acrylate copolymer, fluorinated ethylene propylene, polyvinyl fluoride, ethylene tetrafluoroethylene and cyclicolefin copolymer (COC). By selecting the material and the composition of the polymer interlayer, it is possible to main the mechanical strength of the glass, and achieve many functions such as sound insulation, infrared and ultraviolet blocking, coloring, etc.

During the manufacturing of the upper laminate and the lower laminate, the back glass 5 may be employed to ensure that the surface of the polymer interlayer 2 is flat, the barrier layer 4 may be employed to ensure that the back glass 5 is removed successfully after lamination, and the barrier layer 4 with the smooth and flat surface can ensure that the surface of the polymer interlayer 2 is smooth and flat in the lamination process. In addition, due to the reasons such as an organic solvent may damage a part of the polymer interlayer 2, the surface of the polymer interlayer 2 should be kept as uncleaned or as little cleaned as possible. Therefore, the barrier layer 4 may remain temporarily unremoved in the subsequent process, so as to continuously protecting the polymer interlayer 2 from being contaminated.

The upper laminate specifically may be formed in the following process:
sequentially stacking an upper glass, a first polymer interlayer, an upper polarizer, a first barrier layer and a first back glass to form a laminated structure; after relative positions are fixed, placing the laminated structure into a vacuum bag and laminating by means of a low-temperature and high-pressure (10 bar or more) process; after lamination, removing the vacuum bag, the first barrier layer and the first back glass, and holding an upper laminate formed by the upper glass, the first polymer interlayer and the upper polarizer. In this process, the first polymer interlayer is recessed 1 to 10 mm from a glass edge to accommodate the subsequent arrangement of a perimeter seal.

The lower laminate specifically may be formed in the following process:
sequentially stacking a lower glass, a second polymer interlayer, a lower polarizer, a second barrier layer and a second back glass to form a laminated structure; after relative positions are fixed, placing the laminated structure into a vacuum bag and laminating using a low-temperature and high-pressure (10 bar or more) process; after lamination, removing the vacuum bag, the second barrier layer and the second back glass, and holding a lower laminate formed by the lower glass, the second polymer interlayer and the lower polarizer. In this process, the second polymer interlayer is recessed 1 to 10 mm from a glass edge to accommodate the subsequent arrangement of a perimeter seal.

The upper laminate and the lower laminate are specifically integrated in the following process: making the liquid crystal element be embedded into the liquid optically clear adhesive and interposed between the upper laminate and the lower laminate; after the liquid optically clear adhesive is cured, the upper laminate and the lower laminate are bonded together by the liquid optically clear adhesive to form a multilayer liquid crystal laminated glass.

As illustrated in FIG. 2, a liquid crystal laminated glass with polarizers obtained after integrating includes an upper glass 11, a first polymer interlayer 21, an upper polarizer 31, a liquid optically clear adhesive 6, a lower polarizer 32, a second polymer interlayer 22 and a lower glass 12 which are sequentially laminated.

The liquid optically clear adhesive 6 contains embedded liquid crystal element 7, and the upper polarizer 31, the liquid crystal element 7 and the lower polarizer 32 are correspondingly aligned in a lamination direction.

As illustrated in FIG. 3, the liquid crystal laminated glass with polarizers further includes a perimeter seal 8, which is specifically disposed on the peripheral edges of the liquid optically clear adhesive 6; two ends of the perimeter seal 8 are connected to the upper glass 11 and the lower glass 12, respectively, and an inner side of the perimeter seal 8 is connected to the first polymer interlayer 21, the second polymer interlayer 22 and the liquid optically clear adhesive 6. The perimeter seal 8 is directly connected to the upper glass and the lower glass, which increases an adhesion force between the upper glass and the lower glass, and partially prevents product damage caused by misalignment under external shear force.

In an exemplary solution, before the integrating, the perimeter seal 8 is disposed on the edges of the upper laminate and the lower laminate to keep a distance therebetween when the upper laminate and the lower laminate are bonded by the liquid optically clear adhesive; and an opening is reserved on the perimeter seal 8 to allow the liquid optically clear adhesive to be poured and cured to form the liquid optically clear adhesive 6 in the integrating.

In another exemplary solution, the liquid optically clear adhesive is arranged in the upper laminate or the lower laminate in advance and the liquid optically clear adhesive is embedded with the liquid crystal element 7, then the upper laminate and the lower laminate are combined, and after the liquid optically clear adhesive is cured to form the liquid optically transparent adhesive 6, the perimeter seal 8 is disposed on the opposite peripheral edges of the upper laminate and the lower laminate.

The perimeter seal 8 is primarily configured to connect the upper laminate and the lower laminate, and cooperatively forms an enclosed structure with an internal space of a predetermined height, so as to prevent external particles, moisture, liquid, etc. from entering the enclosed structure. The perimeter seal 8 may be black and opaque, or made of a transparent material that can block the transmission of ultraviolet rays to avoid the aging of the liquid crystal element caused by ultraviolet rays entering the product through the glass edge. The opening is reserved on the perimeter seal 8 to allow the liquid optically clear adhesive to be poured in the integating. After the liquid optically clear adhesive is poured, the opening for pouring may be closed by secondary adhesive injection.

Specifically, the perimeter seal 8 may be disposed for example in the following ways:
1) Before the integrating, the perimeter seal 8 is disposed between a peripheral area of the liquid crystal element 7 and one of the upper laminate and the lower laminate. The perimeter seal 8 may be selected from a double-sided adhesive tape with a relatively fixed thickness (e.g., 3M VHB series), or a silicone or polyurethane structural adhesive with a thickness and a width, or both the double-sided tape with a fixed thickness and the structural adhesive. The perimeter seal 8 has a width of 1 to 10 mm and a height of 0.1 to 2 mm. Two or more openings are reserved on the perimeter seal to allow the liquid optically clear adhesive to be poured.
2) The liquid optically clear adhesive 6 may be disposed on a surface of one of the upper laminate and the lower laminate opposite to the liquid crystal element 7, or a surface of the liquid crystal element 7 opposite to the laminate, then the one of the upper laminate and the lower laminate is bonded with the liquid crystal element 7, and after the liquid optically clear adhesive 6 is cured, the bonding between the liquid crystal element 7 and one of the upper laminate and the lower laminate can be completed;
after the liquid crystal element 7 is integrated with the one of the upper laminate and the lower laminate, the perimeter seal 8 is disposed in a recessed area of the polymer interlayer 2 along the edges of the upper laminate and the lower laminate. The perimeter seal 8 may be selected from a double-sided tape with a relatively fixed thickness (e.g., 3M VHB series), or a silicone or polyurethane structural adhesive with a thickness and a width, or both the double-sided tape with a fixed thickness and the structural adhesive. The perimeter seal 8 has a width of 1 to 10 mm, and a height of 0.2 to 2 mm or more than the sum of the thicknesses of the liquid crystal element 7, the upper polarizer 31, the lower polarizer 32, the first polymer interlayer 21 and the second polymer interlayer 22.
3) After the liquid crystal element 7 is integrated with one of the upper laminate and the lower laminate, a barrier material such as polytetrafluoroethylene or siloxane is optionally arranged in a contracted area of the polymer interlayer 2 between the upper laminate and the lower laminate. The barrier material has a height of 0.2 to 2 mm or more than the sum of the thicknesses of the liquid crystal element, the upper polarizer, the lower polarizer, the first polymer interlayer and the second polymer interlayer. Then, the liquid optically clear adhesive 6 is disposed on a surface of the other of the upper laminate and the lower laminate or the liquid crystal element 7 to combine the upper laminate and the lower laminate, and the barrier material is removed after the liquid optically clear adhesive 6 is cured. The perimeter seal 8 is disposed in a gap between the opposite peripheries of the upper laminate and the lower laminate by injecting a silicone or polyurethane structural adhesive.

In the liquid crystal laminated glass of the present disclosure illustrated in FIGS. 2 and 3, 1) the two polarizers are separated from the film substrate of the liquid crystal element, with the liquid optically clear adhesive filled therebetween, such that even if the polarizers are warped after being heated or irradiated, the liquid crystal element will not be compressed to cause Mura; 2) the polarizer is bonded to the glass using the polymer interlayer and the lamination process, and a high pressure (10 bar or more) may be adopted, thereby avoiding the complicated lamination process debugging and the problems of a weak adhesion of an adhesive material, an incomplete gas removal, etc., which may be caused by a low-pressure process, and better matching the original production line and operators; in addition, the firm adhesion formed in the lamination process of the upper laminate and the lower laminate can effectively suppress the warpage tendency of the polarizers; 3) the liquid crystal element adopts an attaching process of the liquid optically clear adhesive, so as to avoid the permanent Mura or other defects of the liquid crystal element caused by the temperature and the pressure required in the lamination process; 4) during the manufacturing of the upper laminate and the lower laminate, the back glass may be employed to ensure that the surface of the polymer interlayer is flat, the barrier layer may be used to ensure that the back glass is removed smoothly after lamination, and the barrier layer with the smooth and flat surface can ensure that the surface of the polymer interlayer is smooth and flat in the lamination process; in addition, the barrier layer may not be removed temporarily in the subsequent process, so as to continuously protecting the polymer interlayer from being contaminated; and 5) the polymer interlayer in the upper laminate can effectively block ultraviolet rays in sunlight and protect the internal liquid crystal element.

Obviously, the above embodiments of the present disclosure are only examples for clearly explaining the present disclosure, rather than limitations to the embodiments of the present disclosure. Changes or variations of different forms can be made by those of ordinary skill in the art on the basis of the above description, and it is impossible to exhaust all the embodiments here. Any obvious change or variation derived from the technical solutions of the present disclosure still falls within the protection scope of the present disclosure.

1. A method for manufacturing a liquid crystal laminated glass with polarizers, comprising:
combining an upper polarizer with an upper glass to form an upper laminate;
combining a lower polarizer with a lower glass to form a lower laminate; and
integrating: sandwiching a film substrate-encapsulated liquid crystal element without polarizer, between the upper laminate and the lower laminate by arranging, crosslinking and curing a liquid optically clear adhesive, thereby forming the liquid crystal laminated glass.

2. The method for manufacturing a liquid crystal laminated glass with polarizers according to claim 1, wherein a process of forming the upper laminate comprises:
sequentially stacking an upper glass, a first polymer interlayer, an upper polarizer, a first barrier layer, and a first back glass to form a laminated structure; after relative positions are fixed, placing the laminated structure into a vacuum bag and laminating by means of a low-temperature and high-pressure process; after lamination, removing the vacuum bag, the first barrier layer and the first back glass, and holding an upper laminate formed by the upper glass, the first polymer interlayer and the upper polarizer.

3. The method for manufacturing a liquid crystal laminated glass with polarizers according to claim 2, wherein the lamination process employs a low-temperature and high-pressure process with pressure exceeding 10 bar and temperature ranging from 80 °C to 110 °C.

4. The method for manufacturing a liquid crystal laminated glass with polarizers according to claim 1, wherein a process of forming the lower laminate comprises:
sequentially stacking a lower glass, a second polymer interlayer, a lower polarizer, a second barrier layer and a second back glass to form a laminated structure; after relative positions are fixed, placing the laminated structure into a vacuum bag and laminating using a low-temperature and high-pressure process; after lamination, removing the vacuum bag, the second barrier layer and the second back glass, and holding a lower laminate formed by the lower glass, the second polymer interlayer and the lower polarizer.

5. The method for manufacturing a liquid crystal laminated glass with polarizers according to claim 4, wherein the lamination process employs a low-temperature and high-pressure process with pressure exceeding 10 bar and temperature ranging from 80 °C to 110 °C.

6. The method for manufacturing a liquid crystal laminated glass with polarizers according to claim 1, wherein a specific process of the integrating comprises:
making the liquid crystal element be embedded into the liquid optically clear adhesive and interposed between the upper laminate and the lower laminate; after the liquid optically clear adhesive is cured, the upper laminate and the lower laminate together are bonded together by the liquid optically clear adhesive to form the liquid crystal laminated glass.

7. The method for manufacturing a liquid crystal laminated glass with polarizers according to claim 6, wherein before the integrating, a perimeter seal is disposed on edges of the upper laminate and the lower laminate to keep a distance therebetween when the upper laminate and the lower laminate are bonded by the liquid optically clear adhesive; and an opening is reserved on the perimeter seal to allow the liquid optically clear adhesive to be poured in the integrating.

8. The method for manufacturing a liquid crystal laminated glass with polarizers according to claim 6, wherein the liquid optically clear adhesive is arranged in the upper laminate or the lower laminate in advance and embedded with the liquid crystal element, then the upper laminate and the lower laminate are combined, and after the liquid optically clear adhesive is cured, a perimeter seal is disposed on opposite peripheral edges of the upper laminate and the lower laminate.

9. A liquid crystal laminated glass with polarizers, wherein the liquid crystal laminated glass is obtained by a manufacturing method comprising:
combining an upper polarizer with an upper glass to form an upper laminate;
combining a lower polarizer with a lower glass to form a lower laminate; and
integrating: sandwiching a film substrate-encapsulated liquid crystal element without polarizer, between the upper laminate and the lower laminate by arranging, crosslinking and curing a liquid optically clear adhesive, thereby forming the liquid crystal laminated glass.

10. The liquid crystal laminated glass with polarizers according to claim 9, wherein the liquid crystal laminated glass comprises the upper glass, a first polymer interlayer, the upper polarizer, the liquid optically clear adhesive, the lower polarizer, a second polymer interlayer and the lower glass which are sequentially laminated; and wherein
the liquid optically clear adhesive contains embedded liquid crystal element, and the upper polarizer, the liquid crystal element and the lower polarizer are correspondingly aligned in a lamination direction.

11. The liquid crystal laminated glass with polarizers according to claim 10, wherein the liquid crystal laminated glass further comprises a perimeter seal, which is disposed on a peripheral edges of the liquid optically clear adhesive, and two ends of the perimeter seal are connected to the upper glass and the lower glass, respectively.

12. A vehicle, comprising a liquid crystal laminated glass with polarizers, wherein the liquid crystal laminated glass with polarizers is obtained by a method comprising:
combining an upper polarizer with an upper glass to form an upper laminate;
combining a lower polarizer with a lower glass to form a lower laminate; and
integrating: sandwiching a film substrate-encapsulated liquid crystal element without polarizer, between the upper laminate and the lower laminate by arranging, crosslinking and curing a liquid optically clear adhesive, thereby forming the liquid crystal laminated glass.

13. The vehicle according to claim 12, wherein the liquid crystal laminated glass comprises the upper glass, a first polymer interlayer, the upper polarizer, the liquid optically clear adhesive, the lower polarizer, a second polymer interlayer and the lower glass which are sequentially laminated; and wherein
the liquid optically clear adhesive contains embedded liquid crystal element, and the upper polarizer, the liquid crystal element and the lower polarizer are correspondingly aligned in a lamination direction.

14. The vehicle according to claim 13, wherein the liquid crystal laminated glass further comprises a perimeter seal, which is disposed on a peripheral edges of the liquid optically clear adhesive, and two ends of the perimeter seal are connected to the upper glass and the lower glass, respectively.

15. The liquid crystal laminated glass with polarizers according to claim 9, wherein a process of forming the upper laminate comprises:
sequentially stacking an upper glass, a first polymer interlayer, an upper polarizer, a first barrier layer, and a first back glass to form a laminated structure; after relative positions are fixed, placing the laminated structure into a vacuum bag and laminating by means of a low-temperature and high-pressure process; after lamination, removing the vacuum bag, the first barrier layer and the first back glass, and holding an upper laminate formed by the upper glass, the first polymer interlayer and the upper polarizer.

16. The liquid crystal laminated glass with polarizers according to claim 15, wherein the lamination process employs a low-temperature and high-pressure process with pressure exceeding 10 bar and temperature ranging from 80 C to 110 °C.

17. The liquid crystal laminated glass with polarizers according to claim 9, wherein a process of forming the lower laminate comprises:
sequentially stacking a lower glass, a second polymer interlayer, a lower polarizer, a second barrier layer and a second back glass to form a laminated structure; after relative positions are fixed, placing the laminated structure into a vacuum bag and laminating using a low-temperature and high-pressure process; after lamination, removing the vacuum bag, the second barrier layer and the second back glass, and holding a lower laminate formed by the lower glass, the second polymer interlayer and the lower polarizer.

18. The liquid crystal laminated glass with polarizers according to claim 9, wherein a specific process of the integrating comprises:
making the liquid crystal element be embedded into the liquid optically clear adhesive and interposed between the upper laminate and the lower laminate; after the liquid optically clear adhesive is cured, the upper laminate and the lower laminate together are bonded together by the liquid optically clear adhesive to form the liquid crystal laminated glass.

19. The liquid crystal laminated glass with polarizers according to claim 18, wherein before the integrating, a perimeter seal is disposed on edges of the upper laminate and the lower laminate to keep a distance therebetween when the upper laminate and the lower laminate are bonded by the liquid optically clear adhesive; and an opening is reserved on the perimeter seal to allow the liquid optically clear adhesive to be poured in the integrating.

20. The liquid crystal laminated glass with polarizers according to claim 18, wherein the liquid optically clear adhesive is arranged in the upper laminate or the lower laminate in advance and embedded with the liquid crystal element, then the upper laminate and the lower laminate are combined, and after the liquid optically clear adhesive is cured, a perimeter seal is disposed on opposite peripheral edges of the upper laminate and the lower laminate.
